(19) United States
(12) Patent Application Publication
(10) Pub. No.: US 2025/0196389 A1
(43) Pub. Date: Jun. 19, 2025

(54) ADJUSTIBLE HOLD-DOWN SHOE SYSTEM AND METHOD OF MODIFYING A TRIMMER SYSTEM

(71) Applicant: Timber Automation, LLC, Hot Springs, AR (US)

(72) Inventors: James L. Anderson, Florence, SC (US); Russell R. Kennedy, Hot Springs, AR (US); Douglas Monroe Tinsley, Hot Springs, AR (US); Thomas Wayne Green, Hot Springs, AR (US)

(21) Appl. No.: 19/070,162

(22) Filed: Mar. 4, 2025

Related U.S. Application Data
(63) Continuation of application No. 17/739,406, filed on May 9, 2022, now Pat. No. 12,240,140.
(60) Provisional application No. 63/197,543, filed on Jun. 7, 2021.

(51) Int. Cl. B27B 25/06; B27B 5/04

(52) U.S. Cl. CPC B27B 25/06; B27B 5/04

(57) ABSTRACT

An adjustable hold-down shoe system having an assembly body, a plurality of hold-down shoes movably mounted to the assembly body, a body mount, and a lifting/lowering mechanism movably connecting the assembly body to the body mount that moves the assembly body in relation to the body mount and in a first direction towards the lumber bias surface and in a second direction away from the lumber bias surface. A method of modifying a trimmer system by operatively coupling the adjustable hold-down shoe assembly with the trimmer system.

### CROSS REFERENCE TO RELATED APPLICATION

The present application is a continuation of U.S. patent application Ser. No. 17/739,406, filed May 9, 2022, titled “ADJUSTIBLE HOLD-DOWN SHOE ASSEMBLY, PLANERMILL TRIMMER HAVING THE ASSEMBLY MOUNTED THEREON, AND METHOD OF USING THE ASSEMBLY TO HOLD DOWN LUMBER DURING END CUTTING BY A PLANERMILL TRIMMER,” which claims priority to U.S. Patent Application No. 63/197,543, filed Jun. 7, 2021 the entire disclosures of which are incorporated by reference herein.

### TECHNICAL FIELD

The present disclosure relates to a hold-down shoe system that is adjustable to adjust all of the hold-down shoes up and down as a unit, a planermill trimmer having the assembly mounted thereon, and a method of using the hold-down shoe assembly to hold down lumber during end cutting by a planer mill trimmer.

### BACKGROUND

In a sawmilling operation, multi-saw trimmers with saws on nominal 2 foot centers are used to trim both the near end (NE) and far end (FE) of each piece of lumber. The boards are conveyed laterally through the trimmer on lugs at a high rate of speed and each saw raises (and lowers) at the appropriate time to trim the end of the piece according to a manual input, optimized solution (green systems) or grader solution (planermill systems).

Each saw must have a “hold-down” of some sort beside it to 1) hold down the board while sawing, 2) cause the cut-off end to drop out to the waste conveyor below, 3) allow the board to exit the trimmer straight without skewing crossways and 4) keep the board from kicking out of the infeed (or outfeed) of the trimmer, causing damage to equipment or physical injury to surrounding personnel.

In a green system, the boards can be varying thicknesses from 1 inch (or less) up to 6 inch (or more). In this case, the hold-down shoe must be designed to allow each piece the enter under the shoe and into the hold-down (sawing) area. This is not optimal (for speed), but is designed to be the best it can be considering the thickness that must be run through the trimmer. One disadvantage is that the angle of the shoe is different (and not flat at the sawing area) based on the thickness of lumber being sawn.

In a dry (or planermill) system, only one thickness piece is run through the trimmer at a time. This thickness (based on nominal size entering planermill and planer thickness setting) is usually run for several days at a time. This allows for a hold-down shoe that can be optimally set for the incoming lumber thickness. Planermill lumber board piece counts are much higher than sawmill (green) lumber board piece counts. FIG. 1 [Prior Art] illustrates an example of a conventional planermill trimmer in which each hold-down shoe is independently connected to the planermill trimmer and independently adjusted. Even though the conventionally mounted hold-down shoes allow for all thickness of lumber, they are far too aggressive for 6 inch thick lumber and thicker, hammering off the back-end of the lumber and do not allow high speeds to meet customer requirements on the 1 and 2 inch thick lumber. Thick, square, timbers entering the trimmer have often been known to roll back over the lug that is conveying it through the trimmer.

In years past, some planermill trimmers have been made with adjustable mechanisms with straps attached to the rear of the shoe, as shown in FIG. 2 [Prior Art]. When the mechanism was adjusted (with a hydraulic cylinder or manual jack) the shoe would be set so that it moved very little (up and down) when the piece entered the trimmer, thus allowing for higher speeds. However, this type of system is complicated and hard to mount on many trimmer frames.

### SUMMARY

The present disclosure solves the problems of thick lumber slamming off of the conventional hold-down shoes. The present disclosure also provides a far simpler and efficient method of adjusting all of the hold-down shoes simultaneously, and without changing the angle of the hold-down shoes for each thickness of lumber being trimmed.

The objectives of the disclosure and other objectives can be obtained by an adjustable hold-down shoe assembly comprising:
an assembly body;
a plurality of hold-down shoes movably mounted to the assembly body, each hold-down shoe is elongated and has an angled lumber surface configured to slide against lumber, and each hold-down shoe has a lumber bias surface configured to slide against the lumber and bias the lumber in a direction away from the lumber bias surface;
a body mount; and
a lifting/lowering mechanism movably connecting the assembly body to the body mount and is configured to move the assembly body in relation to the body mount and in a first direction towards the lumber bias surface and in a second direction away from the lumber bias surface.

The objectives of the disclosure and other objectives can also be obtained by a planermill trimmer comprising:
a conveyor configured to convey lumber in a first direction;
the planermill trimmer disposed above the conveyor and configured to end cut the lumber on the conveyor;
an adjustable hold-down shoe assembly comprising:
   an assembly body;
   a plurality of elongated hold-down shoes movably mounted to the assembly body, each hold-down shoe having an angled lumber surface configured to slide against the lumber, and each hold-down shoe having a lumber bias surface configured to slide against the lumber and bias the lumber in a direction away from the lumber bias surface and towards the conveyor;
   a body mount connected to the planermill trimmer; and
   a lifting/lowering mechanism movably connecting the assembly body to the body mount and is configured to move the assembly body in relation to the body mount and in a first direction away from the conveyor and in a second direction towards the conveyor.

The objectives of the disclosure can be further obtained by a method of cutting lumber in a planer mill comprising:
providing a planer mill comprising;
   a conveyor configured to convey lumber in a first direction;
   the planermill trimmer disposed above the conveyor and configured to end cut the lumber on the conveyor;
   an adjustable hold-down shoe assembly comprising:
      an assembly body;
      a plurality of elongated hold-down shoes movably mounted to the assembly body, each hold-down shoe having an angled lumber surface configured to slide against the lumber, and each hold-down shoe having a lumber bias surface configured to slide against the lumber and bias the lumber in a direction away from the lumber bias surface and towards the conveyor;
      a body mount connected to the planermill trimmer; and
      a lifting/lowering mechanism movably connecting the assembly body to the body mount and is configured to move the assembly body in relation to the body mount and in a first direction away from the conveyor and in a second direction towards the conveyor;
conveying a piece of lumber on the conveyor;
the lumber sliding against the angled lumber surface and raising the hold-down shoes in a direction away from the conveyor; and
the lumber being biased against the conveyor by the lumber bias surface while the lumber is edge cut by the planermill trimmer.

### BRIEF DESCRIPTION OF THE DRAWINGS

FIG. 1 [Prior Art] illustrates a conventional planermill trimmer having individual hold-down shoes mounted thereon.

FIG. 2 [Prior Art] illustrates a conventional planermill trimmer having an adjustable mechanism having straps attached to rear of each shoe.

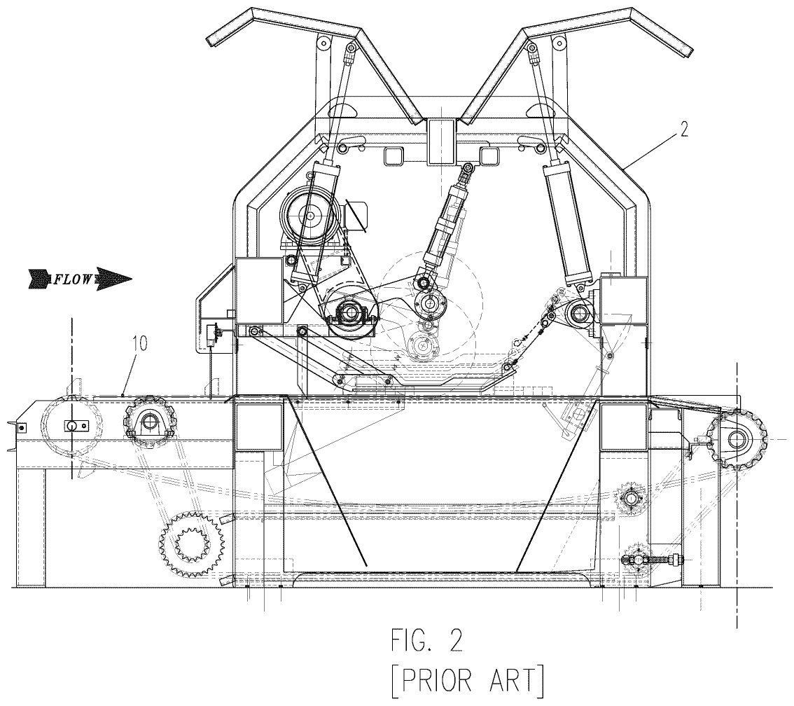

FIG. 3 illustrates a planermill trimmer having mounted thereon an improved hold-down shoe assembly according to the present invention.

FIG. 4 illustrates an angled view of a hold-down shoe assembly according to the present invention.

FIG. 5 illustrates a front view of a hold-down shoe assembly according to the present invention.

FIG. 6 illustrates a side view of a hold-down shoe assembly according to the present invention.

FIG. 7 illustrates a side view of the lifting/lowering gear engaging the lifting/lowering toothed plate.

### DETAILED DESCRIPTION

The invention will now be explained with reference to the attached non-limiting drawings. To facilitate an understanding of the principles and features of the various embodiments of the present invention, various illustrative embodiments are explained below. Although example embodiments of the present invention are explained in detail, it is to be understood that other embodiments are contemplated. Accordingly, it is not intended that the present invention is limited in its scope to the details of construction and arrangement of components set forth in the following description or examples. The present invention is capable of other embodiments and of being practiced or carried out in various ways.

As used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the example embodiments, terminology will be resorted to for the sake of clarity. It is intended that each term contemplates its broadest meaning as understood by those skilled in the art and includes all technical equivalents that operate in a similar manner to accomplish a similar purpose.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified. Such other components or steps not described herein can include, but are not limited to, for example, similar components or steps that are developed after development of the disclosed technology.

While certain implementations of the disclosed technology have been described in connection with what is presently considered to be the most practical and various implementations, it is to be understood that the disclosed technology is not to be limited to the disclosed implementations, but, on the contrary, is intended to cover various modifications and equivalent arrangements included within the scope of the appended claims. Although specific terms are employed herein, they are used in a generic and descriptive sense only and not for purposes of limitation.

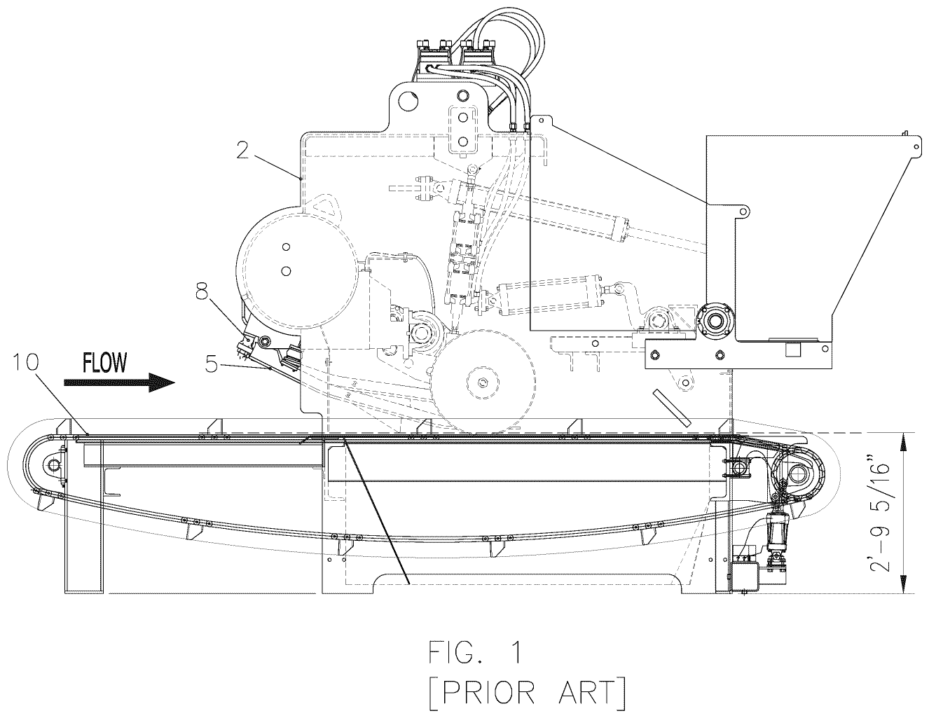

FIG. 1 [Prior Art] illustrates a conventional planermill trimmer 2 having individually mounted conventional hold-down shoes 5. Even though the conventionally mounted hold-down shoes 5 allow for all thicknesses of lumber, they are still far too aggressive for 6 inch thick lumber 12 and thicker, hammering off the back-end of the lumber 12 and do not allow high speeds to meet customer requirements on the 1 and 2 inch thick lumber 12.

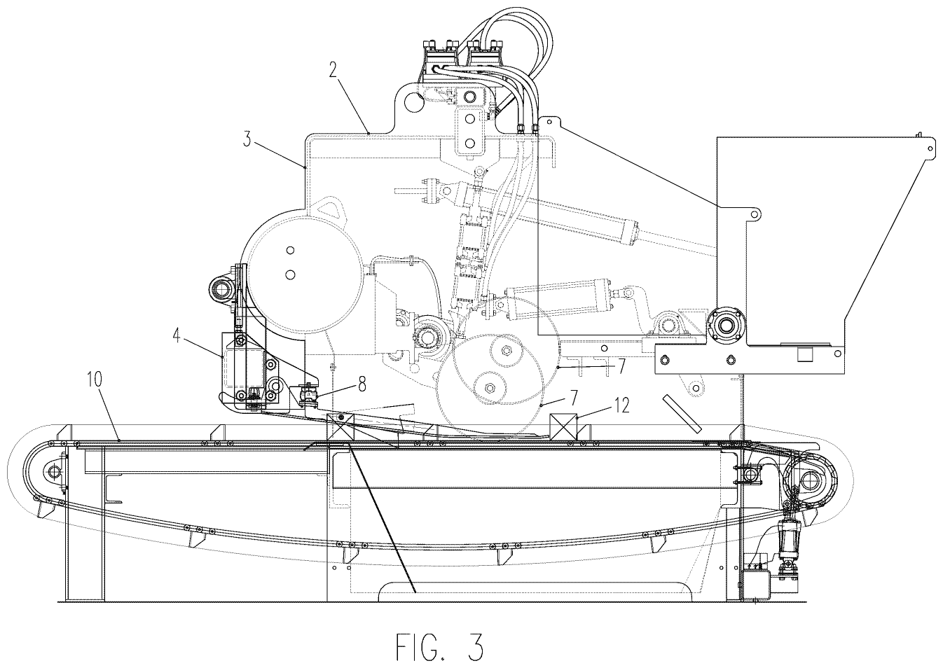

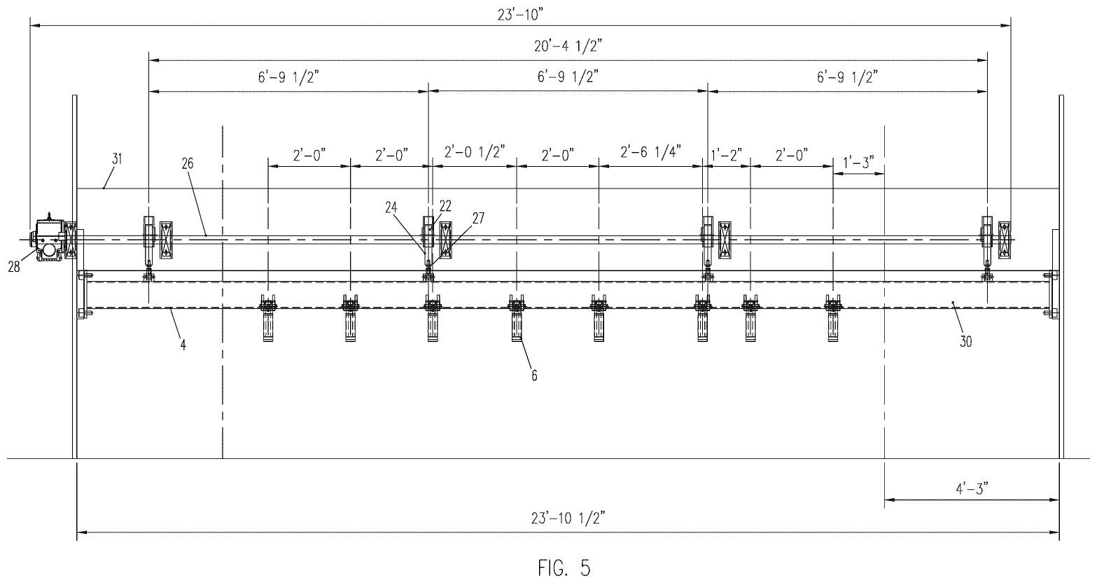

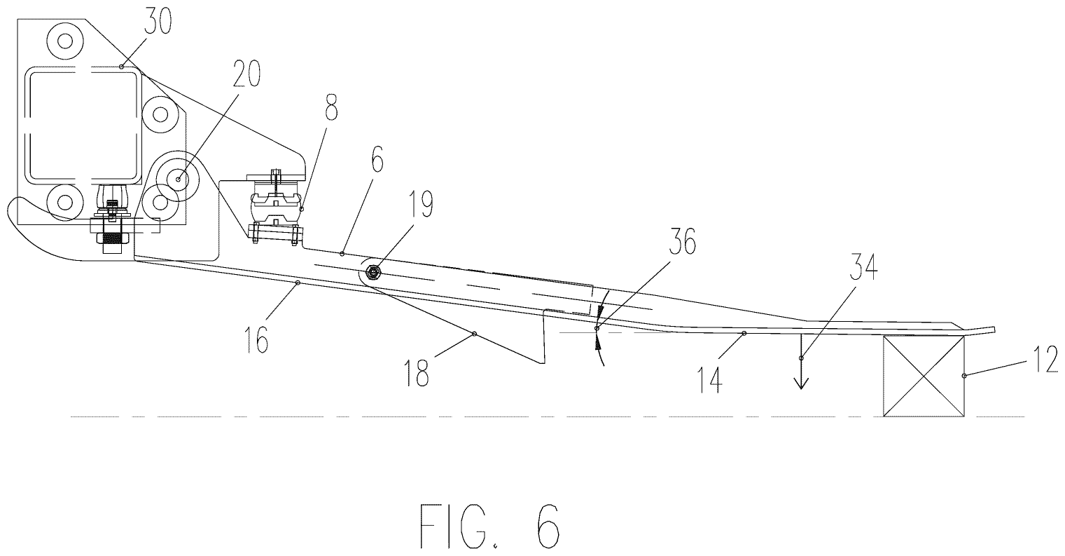

FIGS. 3-6 illustrate a planermill trimmer 2 having an improved hold-down shoe assembly 4 mounted thereon. The hold-down shoes 6 in the present invention can have the same shape and design as the conventional hold-down shoes 5, with the exception of being able to provide a flatter sliding surface angle 36 than the conventional hold-down shoes 5. Examples of a suitable angle 36 is 1 to 25°, preferably from 1 to 20°, more preferably from 1 to 15°, even more preferably from 1 to 10°.

In an example of the present invention produced, the hold-down shoes 6 were mounted on the assembly body 30 with about 2 feet between centers of the hold-down shoes 6. Any desired distance between the hold-down shoes 6 can be utilized. The assembly body 30 comprised a tube that spanned across the front of the planer trimmer 2 and allowed the lumber 12 to pass beneath the assembly body 30. Each of the hold-down shoes 6 has an associated airbag 8. The air-bag 8 can be adjusted to add additional hold-down pressure (bias) on the lumber 12 being end trimmed. Air-bags 8 are now well known and any suitable air-bag 8 and associated equipment to operate and control the air-bag 8 can be utilized.

Since the entire assembly body 30 with all of the hold-down shoes 6 can be adjusted up and down in relation to the conveyor 10, the angle 36 for each different size of lumber can remain the same and the hold-down shoes 6 do not hammer off the back of the lumber 12 when the angled lumber surface 16 contacts the lumber 12. Furthermore, each piece of lumber 12 can now come gently into the angled lumber surface 16 without fear of rolling larger lumber 12, such as square 4 inch×4 inch or 6 inch×6 inch lumber 12.

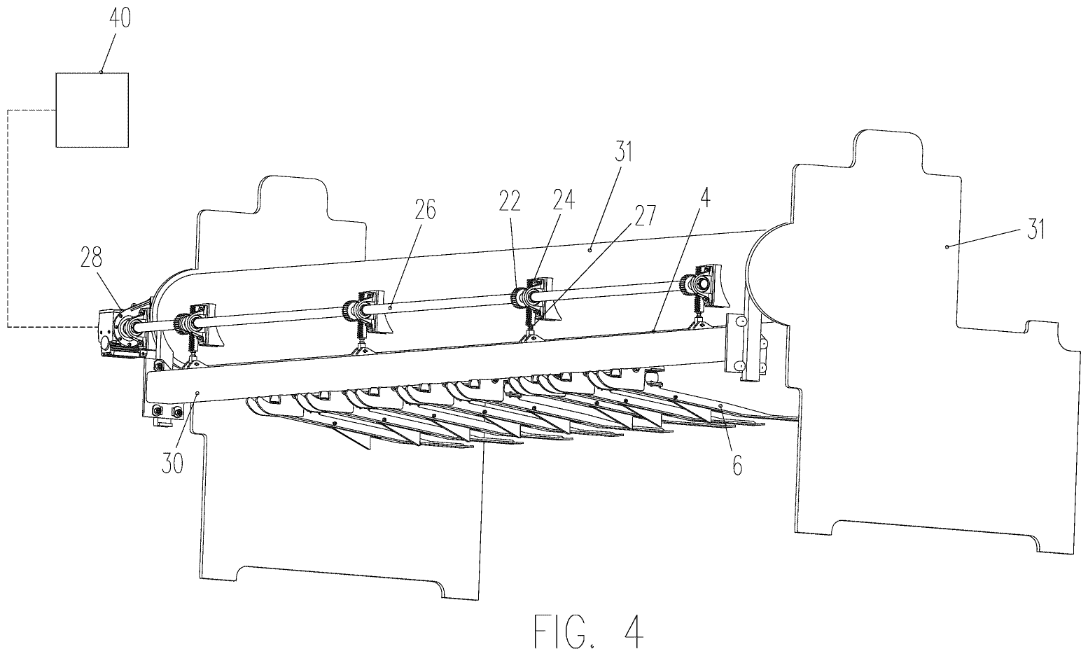

FIGS. 4-7 illustrate a lifting/lower device movably connecting the assembly body 30 to the body mount 31. The lifting/lowering device is configured to move the assembly body 30 in relation to the body mount 31 and in a first direction away from the lumber bias surface 14 and towards the conveyor 12, and in a second direction the lumber bias surface 14. The lifting/lowering device comprises a lifting/lowering gear 22 having gear teeth 23 that is mounted on a gear drive shaft 26 driven by a lifting/lowering motor 28, a lifting/lowering toothed plate 24 having plate teeth 25, and the plate teeth 25 engaging the gear teeth 23. The lifting/lowering gear 22 and the gear drive shaft 26 are on the body mount 31 and the lifting/lowering toothed plate 24 is connected to the assembly body 30. In the example shown in the Figs, the assembly body 30 is held so that its movement is limited to straight up and down only by the use of four sets of lifting/lowering gears 22 and associated lifting/lowering toothed plates 24. Rotating the gear drive shaft 26 rotates the lifting/lowing gears 22 which moves the lifting/lowering toothed plates 24 in relation to the lifting/lowering gears 22.

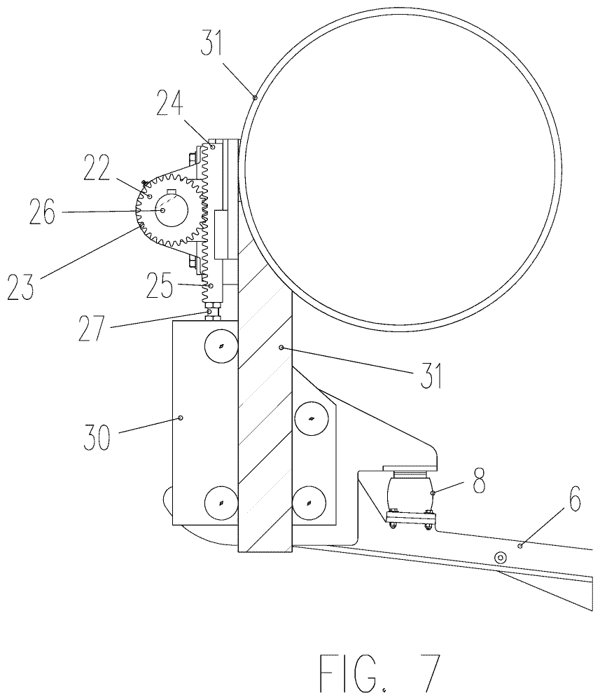

In order to add strength in a y-axis (vertical) for the full-spanning tube (assembly body 30) with the hold-down shoes 6 attached, several racks (gear 22 and plate 24) can be attached across the span of the assembly body 30. FIG. 7 shows one of these racks up-close. The gear drive shaft 26 not only lifts the hold-down shoes 6 and assembly body 30 when rotated, but acts as an equalizer or stabilizer so that each end of the assembly body 30 is lifted equally, keeping the hold-down shoe assembly 4 parallel with the flow of the lumber 12 on the conveyor 10, i.e. not tilted. The lifting/lowing toothed plate 24 can be mounted to the assembly body 30 using an adjustable tie rod 27 to make adjustments for any manufacturing discrepancies or assembly body 30 deflection. Lifting and lowering of the assembly body 30 lifts and lowers all of the hold-down shoes 6 at the same time to adjust for the thickness of the lumber 12. The sliding surface angle 36 is preferably not changed during the lifting and lowering of the assembly 4.

The lifting/lowering motor 28 can be a servo motor (with encoder feedback) for setworks placement. If desired, the lifting/lowering motor 28 can be replaced with a hand-crank for manual adjustment. Another example of the lifting/lowering device includes an electric or hydraulic cylinder, with or without electronic feedback. In the present example, the lifting/lowering motor 28 was an electric motor with absolute encoder (for position feedback) and electric brake for holding position during operation. In this manner, the settings can be the same for a number of shifts or days. A self-locking reducer can be utilized. However, a brake is preferably used to ensure that the assembly body 30 does not move during operation of the planermill trimmer 2. The settings of the servo motor hold-down shoes can be done by a computer system 40 based on the product thickness being manufactured.

In the current design, the mechanism will mount directly to the front of the Timber Automation trimmer, but it is envisioned that future designs for trimmers manufactured by other OEMS, the mechanism could be made free-standing as well.

### REFERENCE NUMBERS

2 Planermill trimmer
3 Trimmer
4 Hold-down shoe assembly
5 Prior art hold-down shoe
6 Hold-down shoe
7 End trimming saw
8 Air bag
10 Conveyor
12 Lumber
14 Lumber bias surface
16 Angled lumber surface
18 Anti-kick-back stop
19 Stop movable mount
20 Shoe movable mount
22 Lifting/lowering gear
23 Gear teeth
24 Lifting/lowering toothed plate
25 Plate teeth
26 Gear drive shaft
27 Adjustable tie rod
28 Lifting/lowering motor
30 Assembly body
31 Body mount
34 Bias towards conveyor
36 Sliding surface angle
40 Computer system

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, processes and uses, such as are within the scope of the appended claims. Those skilled in the art, having the benefit of the teachings of this specification, may affect numerous modifications thereto and changes may be made without departing from the scope and spirit of the invention.

1. An adjustable hold-down shoe system comprising:
an assembly body, wherein the assembly body includes an elongated support member;
a plurality of elongated hold-down shoes mounted to the elongated support member and oriented transverse thereto, each one of the hold-down shoes having an angled lumber surface configured to slide against a piece of lumber, and a lumber bias surface configured to slide against the piece of lumber and bias the piece of lumber downwardly toward the conveyor;
a body mount; and
a lifting/lowering mechanism configured to movably connect the assembly body to the body mount and to raise and lower the assembly body relative to the body mount.

2. The adjustable hold-down shoe system of claim 1, wherein each of the hold-down shoes has a first end and an opposite second end, and wherein the first ends of the hold-down shoes are pivotably coupled to the elongated support member.

3. The adjustable hold-down shoe system of claim 2, further including one or more bias devices connecting the hold-down shoes to the assembly body and configured to bias the hold-down shoes downwardly relative to the assembly body.

4. The adjustable hold-down shoe system of claim 2, wherein at least one of the hold-down shoes includes an anti-kick-back stop configured to allow the piece of lumber to move along the angled lumber surface in a first direction toward the second end of said hold-down shoe and to inhibit movement of the piece of lumber along the angled lumber surface in a second direction toward the first end of said hold-down shoe.

5. The adjustable hold-down shoe system of claim 3, wherein a first end of the anti-kick-back stop is pivotably coupled to said hold-down shoe such that an opposite second end of the anti-kickback stop is pivotable upwardly by contact with the piece of lumber as the piece of lumber moves along the angled lumber surface in the first direction.

6. The adjustable hold-down shoe system of claim 1, wherein the lifting/lowering mechanism includes a first portion and a second portion, the first portion includes a shaft and a gear mounted along the shaft, the gear having a plurality of gear teeth, and the second portion includes a toothed plate configured to moveably engage the gear teeth of the gear, and wherein one of said portions of the lifting/lowering mechanism is connected to the assembly body and the other one of said portions of the lifting/lowering mechanism is connected to the body mount.

7. The adjustable hold-down shoe system of claim 6, wherein the first portion of the lifting/lowering mechanism includes one or more additional gears mounted along the shaft, and the second portion of the lifting/lowering mechanism includes a corresponding one or more additional toothed plates, each of said gears configured to engage a corresponding one of said toothed plates.

8. The adjustable hold-down shoe system of claim 7, wherein the shaft is rotatably mounted to the body mount and the gears are spaced apart along the shaft, and wherein the tooted plates are mounted to the assembly body at corresponding locations.

9. The adjustable hold-down shoe system of claim 6, further including a mechanism operable to rotate the shaft, wherein said mechanism includes a servo motor, a hand-crank, an electric cylinder, or a hydraulic cylinder.

10. The adjustable hold-down shoe system of claim 9, wherein the mechanism for rotating the shaft includes an electric motor, and the system further includes a computer system operatively coupled with the electric motor and programmed with instructions that are operable, upon execution by one or more processors of the computer system, to operate the electric motor based on lumber thickness.

11. A method of modifying a trimmer system, wherein the trimmer system includes a conveyor configured to convey a piece of lumber in a first direction along a path of travel, a frame, and a saw movably mounted to the frame and operable to cut the piece of lumber transversely on the conveyor within a sawing area, the method comprising:
operatively coupling an adjustable hold-down shoe system as recited in claim 1 with the trimmer system such that the assembly body extends above and across the path of travel upstream of the frame, one or more of the hold-down shoes extends into the sawing area, and the lifting/lowering mechanism is operable to raise and lower the assembly body relative to the body mount to thereby adjust a height of the hold-down shoes relative to the conveyor.

12. The method of claim 11, wherein operatively coupling the adjustable hold-down shoe system with the trimmer system includes mounting the body mount to an upstream end of the frame of the trimmer system.

13. The method of claim 11, wherein the adjustable hold-down shoe system is configured to be free-standing, and wherein operatively coupling the adjustable hold-down shoe system with the trimmer system includes positioning the body mount above the conveyor and upstream of the frame.

14. The method of claim 11, wherein the body mount is a portion of the frame, and operatively coupling the adjustable hold-down shoe system with the trimmer system includes mounting a first portion of the lifting/lowering mechanism to the body mount.

15. The method of claim 11, wherein each of the hold-down shoes has a first end and an opposite second end, the first ends of the hold-down shoes are pivotably coupled to the elongated support member, and one or more bias devices connect the hold-down shoes to the assembly body, the method further including operating the one or more bias devices to thereby adjust a hold-down pressure to be applied by the hold-down shoes.

16. The method of claim 11, wherein at least one of the hold-down shoes includes an anti-kick-back stop configured to allow the piece of lumber to move along the angled lumber surface in a first direction toward the second end of said hold-down shoe and to inhibit movement of the piece of lumber along the angled lumber surface in a second direction toward the first end of said hold-down shoe.

17. The method of claim 16, wherein a first end of the anti-kick-back stop is pivotably coupled to said hold-down shoe such that an opposite second end of the anti-kickback stop is pivotable upwardly by contact with the piece of lumber as the piece of lumber moves along the angled lumber surface in the first direction.

18. The method of claim 11, wherein a first portion of the lifting/lowering mechanism a shaft and one or more gears mounted along the shaft, and a second portion of the lifting/lowering mechanism includes one or more toothed plates configured to moveably engage the one or more gears, and wherein operatively coupling the adjustable hold-down shoe system with the trimmer system includes connecting one of said portions of the lifting/lowering mechanism to the assembly body and connecting the other one of said portions of the lifting/lowering mechanism to the body mount, such that each of the one or more gears is in engagement with a corresponding one of the one or more toothed plates.

19. The method of claim 18, further including operatively coupling the shaft with a mechanism operable to rotate the shaft, wherein said mechanism includes a servo motor, a hand-crank, an electric cylinder, or a hydraulic cylinder.

20. The method of claim 19, wherein the mechanism for rotating the shaft includes an electric motor, the method further including operatively coupling the electric motor with a computer system programmed with instructions that are operable, upon execution by one or more processors of the computer system, to operate the electric motor based on lumber thickness.
